(19) United States
(12) Patent Application Publication
(10) Pub. No.: US 2007/0019173 A1
(43) Pub. Date: Jan. 25, 2007

(54) Photolithography arrangement

(75) Inventor: Reinhard Marz, Munich (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Munich (DE)

(21) Appl. No.: 11/332,779

(22) Filed: Jan. 12, 2006

(30) Foreign Application Priority Data
Jan. 13, 2005 (DE) 10 2005 001 671.5

(51) Int. Cl. G03B 27/42

(52) U.S. Cl. 355/53

(57) ABSTRACT

A photolithography arrangement including an illumination source, which emits radiation with a predetermined wavelength directed towards a substrate, a projection mask for modulating the radiation of the illumination source, an optical system for imaging the radiation modulated by the projection mask onto the substrate, and a metal mask, which includes a transparent mask carrier and a metal mask arranged thereon, arranged successively in the beam path. The metal mask is designed so that the modulated radiation is transmitted through the metal mask by means of surface plasmons.

### BACKGROUND OF THE INVENTION

The invention relates to a photolithography arrangement.

It is an aim of the semiconductor industry to constantly reduce the achievable structure size so that more structures, for example transistors, can be formed on a given area. Integration of more and more transistors on a chip and a low power consumption of the individual transistors are two advantages of such miniaturized semiconductor structures. As regards photolithography devices, one way of reducing the achievable structure size is to shorten the wavelength used. A wavelength of 193 nm is used at present, which is generated with the aid of ArF excimer lasers.

Shortening the wavelength, however, entails many technical and economic problems since the new technology has to be mastered before industrial use, and upgrading to a new process technology requires entirely new processing systems, which are very expensive.

Another way of reducing the achievable structure sizes is to use suitable imaging optics which are capable of further reducing the achievable structure sizes (for example to as little as 130 nm by means of calcium fluoride optics). Using phase masks, it is even possible to generate a structure size of as little as 65 nm.

According to the conventional view, further miniaturization of the projection masks reaches its limits when the dimensions of the structures of the projection mask (for example a through hole) are of the order of or less than of the wavelength used. Then, according to the conventional understanding of optics, it is to be expected that the radiation will emerge entirely isotropically into the half-space on the light exit side of the projection mask. It is known from H. J. Lezec, A. Gegiron, E. Devaux, R. A. Linke, L. Martin-Moreno, F. J. Garcia-Vidal, T. W. Ebbesen, Science 297, 820 (2002) (hereinafter “Lezec”); L. Martin-Moreno, F. J. Garcia-Vidal, H. J. Lezec, A. Degiron and T. W. Ebbesen, Phys. Rev. Lett., Vol. 90, p. 167401, (2003) (hereinafter “Moreno”); and X. Luo, and T. Ishihara, Applied Physics Letters 84, 4780-4782 (2004) (hereinafter “Luo”), however that the emerging ray bundle can have a very small aperture angle under certain circumstances.

An arrangement having a metal film for improved light transmission is known from Ebbesen et al. (U.S. Pat. No. 6,236,033 B1, hereinafter “Ebbesen”). Through holes are arranged in the metal film. The metal film furthermore has a periodic surface topography on at least one side. The improved transmission is achieved because the incident light interacts with surface plasmon modes on the surface of the metal film, so that the transmission via the through holes in the metal film is improved.

An exposure method and an arrangement are known from WO 2004/114024 A2, a photoresist being exposed by using a near-field mask.

A method for structuring a photoresist is known from JP 57010232 A, a transparent fluid substance being arranged between the photoresist layer and the photomask in order to achieve a finer photoresist structure.

### BRIEF SUMMARY OF THE INVENTION

The invention provides a photolithography arrangement which makes it possible to generate smaller structures in comparison with the exposure wavelength.

A photolithography device according to the invention includes an illumination source which emits radiation with a predetermined wavelength directed towards a substrate, a projection mask for modulating the radiation of the illumination source, an optical system for imaging the radiation modulated by the projection mask onto the substrate; and a metal mask, which includes a transparent mask carrier and a metal mask arranged thereon, being arranged successively in the beam path. The metal mask is designed to transmit the modulated radiation through the metal mask by means of surface plasmons.

This arrangement clearly makes it possible for very fine semiconductor structures to be produced, since the radiation is focused by an optical system after it has been modulated when passing through the projection mask, and a metal mask, which transmits the focused modulated radiation by means of surface plasmons through the metal mask and exposes the substrate lying behind it in the beam path, is arranged between the optical system and the substrate in order to further increase the resolution.

In the one refinement, the thickness of the metal mask corresponds essentially to the predetermined wavelength, and the metal mask comprises at least one through hole which is dimensioned so that it is smaller than the predetermined wavelength. The metal mask may furthermore include a grating structure on its light exit side for converting the surface plasmons into directed light.

Expressed another way, a metal mask having these properties makes it possible for radiation arriving at a through hole on the light incidence side of the metal mask to leave the through hole with a very small aperture angle. Since the through hole is smaller than the wavelength, it is therefore possible to generate structures which are smaller than the through hole.

Preferably, the through hole is circular and the circular through hole is surrounded by annular grating structures.

This means that the circular through hole is surrounded by annular, preferably concentric grating structures, the through hole preferably being centered at the mid-point of the annular grating structures. With such an arrangement, it is possible for a point-like structure to be formed on the substrate with a size which is even smaller than a width of the wavelength.

Non-periodic structures, or expressed another way for example chirped structures, are provided in an alternative configuration of the invention i.e. the indentations and elevations may be arranged non-periodically with respect to their positioning in the grating structure, freely selectably in the plane of the metal mask. This clearly means that the grating structure may comprise irregularly arranged indentations and elevations.

Preferably, the through hole has a width which is significantly less than the wavelength and a multiplicity of grating structures are arranged perpendicularly to the width of the through hole, and preferably symmetrically with respect to the through hole.

Simply speaking, this means that the metal mask comprises a slot-shaped through hole and the length, although not fixed, may be very much greater than the width. Here and in what follows, the term through hole is intended to mean an opening which extends through the metal mask. A grating line is respectively arranged parallel to the slot-shaped through hole and at an equal distance from the through hole on its left and right hand sides, so that a linear structure is formed on the substrate when a metal mask having such a through hole is used, the width of the line being substantially smaller than the wavelength and the length of the line being unrestricted.

Preferably, the metal mask is arranged at a distance from the substrate and the space between the second projection mask and the substrate is at least partially filled with an immersion liquid.

The effect achieved by applying the mask at a distance from the substrate is that the mask will not be damaged. This risk exists above all when the substrate comes in contact with the mask. In particular, the distance between the second projection mask and the substrate is selected so that the substrate lies in the near-field region of the second projection mask. This means that the distance is preferably not more than ten times the diameter of the through hole. In the defined distance range, with a suitable layout, the diameter of the image on the substrate is then minimal. It is advantageous to fill the space between the projection mask and the substrate with an immersion liquid because the numerical aperture and therefore the resolving power of the photolithography device can be increased in this way.

For the “G line” (436 nm), the metal mask is preferably made of silver.

The advantage using silver as a material for the metal mask is that silver masks have already been widely studied in the scientific literature, and their suitability for the conduction of plasmons has been demonstrated.

The metal mask preferably comprises a second grating structure on the light incidence side, which is arranged around the through hole, in order to increase the transmission.

For example, the second grating structure on the light incidence side of the mask makes it possible to control the exposure of the substrate.

With the described photolithography arrangement, it is therefore possible to generate structures which are smaller than the wavelength used by using a photolithography arrangement having two masks, one mask being a metal mask and the other mask being a projection mask.

Simply embodiments of the invention are represented in the drawings and will be explained in more detail below.

### BRIEF DESCRIPTION OF THE DRAWINGS

FIG. 1 shows a photolithography arrangement according to the exemplary embodiment of the invention;

FIG. 2A shows a cross-sectional view of an exemplary embodiment of a metal mask;

FIG. 2B shows a plan view of an exemplary embodiment of the metal mask for generating point-like structures;

FIG. 2C shows a plan view of an exemplary embodiment of the metal mask for generating linear structures; and

FIG. 3 shows method steps for producing the metal mask.

### DETAILED DESCRIPTION OF THE INVENTION

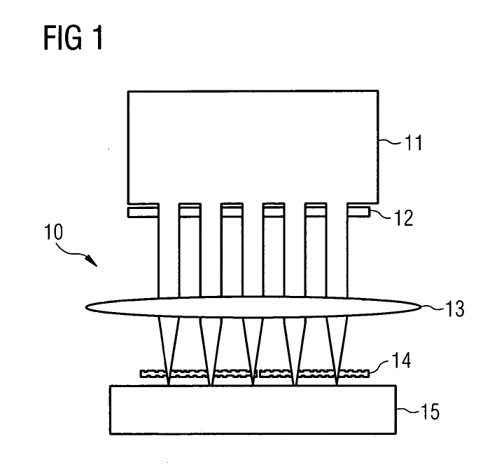

The structure of a photolithography arrangement according to the invention will be described with reference to FIGS. 1 to 3.

FIG. 1 represents a photolithography arrangement according to the invention in cross section. The drawing represents a radiation bundle 11, a projection mask 12, an optical system 13, a metal mask 14 and a substrate 15.

The radiation bundle 11 is generated, for example, by an excimer laser (not shown) and has a wavelength of for example 193 nm. Alternatively, it is also possible to use other wavelengths of the electromagnetic spectrum if they are suitable for exposure of the substrate 15.

The emitted ray bundle 11 strikes the projection mask 12, so that the ray bundle 11 becomes modulated according to the structures to be imaged. Expressed another way, this means that the projection mask 12 comprises first regions that block parts of the ray bundle 11 and second regions that transmit parts of the ray bundle 11, so as to expose those sections of the substrate 15 which are intended to be exposed.

The modulated ray bundle 11 strikes an optical system 13, which is represented as a single lens in FIG. 1 but in practice comprises a plurality of lenses and diaphragms. The optical system 13 is used to focus the modulated ray bundle 11 onto the substrate 15, so as to generate a correspondingly high radiation dose on the substrate 15 and particularly in the intended regions of the substrate 15, in order to structure the substrate 15 there.

The modulated and partially focused ray bundle 11 strikes the metal mask 14 before it strikes the substrate 15. The metal mask 14 is used as a second projection mask, and is preferably made of silver. The mask 14 may alternatively be made of other materials, including for example gold. The metal mask 14 is designed in order to transmit the modulated ray bundle 11 via through holes in the metal mask 14 by means of surface plasmons. Here and in what follows, the term through holes refers to openings in the metal mask 14 which extend through the metal mask 14.

A transparent carrier substrate for supporting the metal mask 14, on which the metal mask 14 is applied, is not represented in FIG. 1. This carrier substrate is preferably made of quartz glass, although it may also be formed from any other suitable material so long as it is transparent and flat.

The advantage of using this carrier substrate is that it can achieve good alignment of the mask 14, with constant distances between the metal mask 14 and the substrate 15 over the entire exposure field.

Since the carrier substrate is transparent, positioning marks may be arranged on the rear side i.e. the light exit side of the carrier substrate, which allow particularly exact alignment of the metal mask 14 so that the overlay accuracy of the projection lithography arrangement 10 can be transferred onto the substrate 15. In conjunction with these positioning marks and the internal interferometer control, it is thus possible to achieve a positioning accuracy as in projection exposure machines (currently in the range of approximately 50 nm).

The proposed photolithography arrangement 10 is also suitable for exposure control, either by accordingly adapting the grating structure on the light incidence side of the metal mask 14 or by focusing the ray bundle 11 differently by means of the projection mask 12.

The metal mask 14 may also have large through holes, which are large enough to allow conventional exposure of the substrate 15 through the metal mask 14.

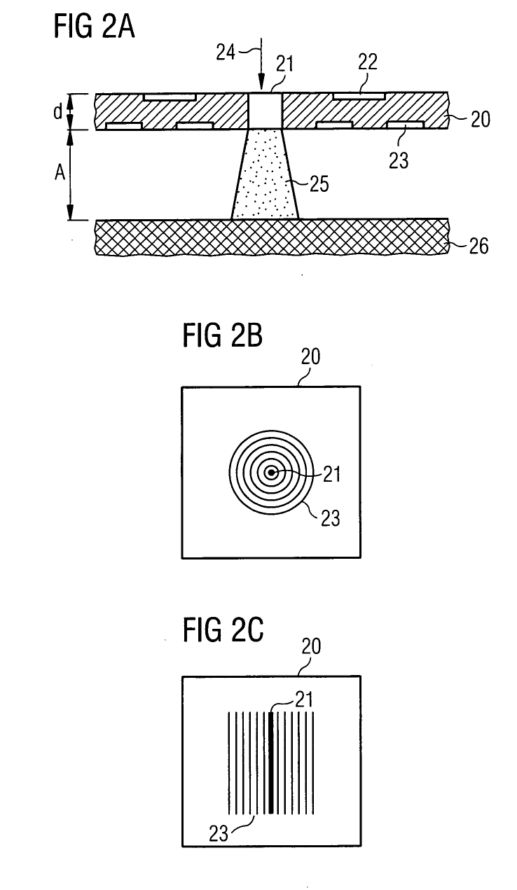

FIGS. 2A-2C show the metal mask in more detail. FIG. 2A shows a cross section through the metal mask and FIGS. 2B and 2C show plan views of a metal mask, the metal mask in FIG. 2B being designed to expose a point-like structure and the metal mask in FIG. 2C being designed to expose a linear structure.

The metal mask 20 comprises a grating structure 22 on the front side, a grating structure 23 on the rear side and a through hole 21. “Front side” and “rear side” are in this case defined with respect to an incident ray bundle, which is indicated by the arrow 24. This means that the grating structure 22 lies on the light incidence side of the metal mask 20, and the grating structure 23 lies on the opposite light exit side of the metal mask. The metal mask 20 is arranged at a distance A from the substrate 26.

A thickness d of the metal mask 20 is of the order of the predetermined wavelength, and the diameter or width of the through hole 21 is significantly less than the predetermined wavelength. For example, FIG. 1A of Lezec et al. represents a silver metal mask whose thickness is 300 nm and whose through hole has a diameter of 250 nm, it having been established for this metal mask that the maximum transmission intensity directly behind the through hole is achieved at a wavelength of 660 nm.

The grating structure 23 is provided on the light exit side of the metal mask 20 in order to generate a directed output radiation bundle 25. The grating structure 23 has indentations and elevations, the indentations having a depth relative to the elevations which is substantially flatter than the thickness d of the metal mask 20. The indentations and elevations are arranged alternately and uniformly in the plane of the metal mask 20, the width of the indentations and elevations advantageously being identical and approximately having a periodicity which is of the order of the wavelength used. The grating structure furthermore has symmetrical indentations which, as can be seen from FIG. 1A in Lezec et al., have for example a depth of 60 nm and a periodicity of 500 nm, i.e. the indentations and elevations are respectively 250 nm wide.

Non-periodic structures, or expressed another way for example chirped structures, are provided in an alternative configuration of the invention, i.e., the indentations and elevations may be arranged non-periodically with respect to their positioning in the grating structure 23, freely selectably in the plane of the metal mask 20. This clearly means that the grating structure 23 may comprise irregularly arranged indentations and elevations.

Such a metal mask 20 is suitable for emitting a radiation bundle 25 on the light exit side which has a very small aperture angle of for instance 3°. Since the through hole 21 is smaller than the wavelength, it is therefore possible to expose very small structures.

Physically, the effect is based on surface plasmons being generated on the front side and the rear side of the metal mask 20 by the incident ray bundle 24. Although these are strictly speaking surface plasmons, the term “plasmons” will be used below. The plasmons propagate along the surface, and possibly also along the inner wall of the through hole 21, onto the rear side of the metal mask 20. The effect of the grating structure 23 on the rear side of the metal mask 20 is that electromagnetic waves are emitted by scattering from the grating structure 23, interference causing the ray bundle 25 to have only a very small aperture angle.

The photolithography arrangement therefore makes it possible to produce very fine semiconductor structures, since the radiation is focused and reduced in size after it has been modulated when passing through the projection mask, and a metal mask, which has very small through holes, is arranged between the optical system and the substrate in order to further increase the resolution. The radiation leaves the through hole with a very small aperture angle owing to plasmon effects. Since the through hole is smaller than the wavelength, it is therefore possible to generate structures which are much smaller than the wavelength.

On the front side, the metal mask 20 has a second grating structure 22 which is arranged concentrically and uniformly around the through hole 21. The second grating structure 22 has a different depth and a different width of indentations, i.e. grooves, and elevations than the periodicity of the first grating structure 23, so that the indentations and elevations on the two surfaces of the metal mask 20 do not generally lie opposite. The grating structure 22 is designed so as to increase the transmissivity of the radiation through the metal mask 20.

Alternatively, the grating structure 21 on the front side of the metal mask 22 may be omitted since the grating structure 22 does not influence any imaging properties other than the transmissivity.

The metal mask 20 is arranged in the photolithography arrangement 10 according to the invention so that the grating structure 23 lies opposite the substrate (not shown in FIG. 2A) and is separated from it by a distance. The intermediate space between the metal mask 20 and the substrate may be partially or entirely filled with an immersion liquid (not shown). The immersion liquid typically has a low surface tension, so that the grating structure 23 is fully wetted. Water, glycerol or immersion oil, for example, may be used as the immersion liquid.

The through hole may, for example, be a circular opening as represented in FIG. 2B or a slot-shaped or linear opening, as represented in FIG. 2C. FIGS. 2B and 2C are plan views of the rear side of the metal mask. According to the shape of the through hole, corresponding structures can be exposed on the substrate.

FIG. 2B shows a circular through hole 21 which is surrounded by a concentric annular grating structure 23, the circular through hole 21 being located at the common mid-point of the annular structures 23. The grating structure 23 is arranged uniformly. The metal mask is denoted by the reference numeral 20. The cross section of this structure corresponds to the cross section represented in FIG. 2A.

FIG. 2C shows a linear or slot-shaped through hole 21. The width of the through hole 21 is less than the wavelength used, and the length of the through hole 21 is in principle not restricted. The substrate furthermore comprises a multiplicity of grating structures 23, which extend parallel to the linear through hole 21 and symmetrically with respect to the linear through hole 21. The grating structure 23 is furthermore arranged uniformly. The metal mask is denoted by the reference numeral 20. The cross section of this structure corresponds to the cross section represented in FIG. 2A.

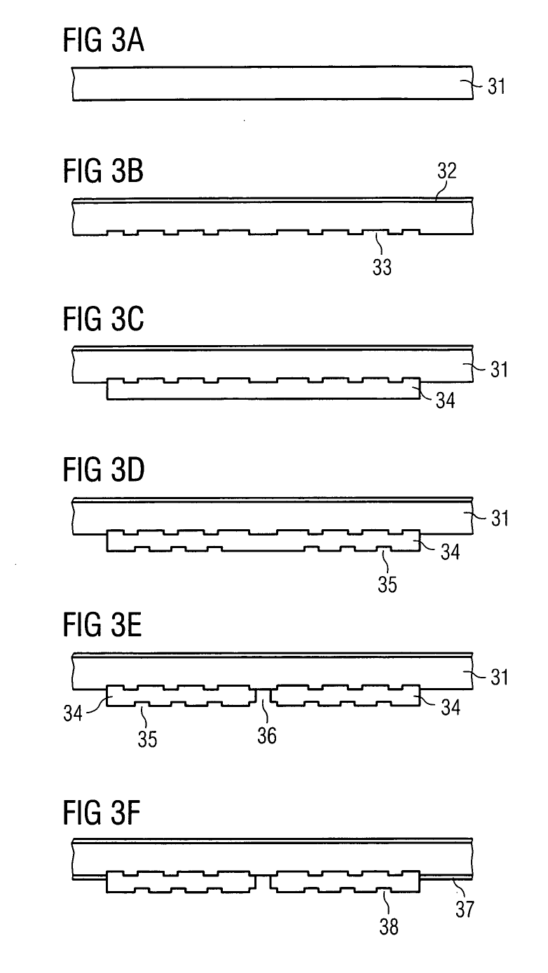

FIG. 3 shows method steps for producing the metal mask. Although the production method is shown for a single metal mask in FIG. 3, it is possible to produce a multiplicity of metal masks simultaneously.

In step a), a carrier substrate 31 which is preferably made of SiO₂ (quartz glass) is prepared. The carrier substrate 31 may nevertheless be made of any other suitable material, so long as it is transparent and smooth.

In step b), the carrier substrate 31 is provided with an anti-reflection layer 32 on the upper side, i.e. the light incidence side. The carrier substrate 31 is furthermore provided on the rear side, i.e. the light exit side, with a grating structure 33 which is the negative image of the grating structure in order to increase the transmission ratio on the metal mask.

In step c), the rear side of the carrier substrate 31 is coated with a suitable metal which is intended to be the basis of the mask, for example silver, and planarized. A metal layer 34 is thus formed on the rear side of the carrier substrate 31, the thickness of the metal layer 34 being a few 100 nm.

In step d), the rear side of the metal layer is structured and thus provided with a grating structure 35, which is suitable for generating directed electromagnetic radiation by means of plasmons. After the structuring, the grating structure has elevated and indented sections in the plane of the metal layer 34. Elevated sections exist wherever less or no material has been removed from the metal layer 34, while indented sections exist wherever more material has been removed from the metal layer 34. Preferably, 60 nm are removed in indented sections while no material is removed in elevated sections. The periodicity of elevated and indented sections in the plane of the metal layer 34 is for example 600 nm, the width of elevated and indented sections being essentially identical.

In step e), a through hole 36 is generated in the center of the grating structure 35. Here, it should be made clear that the two structures provided with the reference 34 in FIG. 3E represent a single continuous metal layer 34.

In step f), a thin non-reflecting layer 37 is applied on open regions of the carrier substrate 31. The thin layer 37 is not applied in the region of the through hole 36 and is not applied in the region of the metal layer 34. The metal layer 34 with the grating structure 35 and the through hole 36 constitutes the metal mask 38.

The next step, in which the multiplicity of metal masks 38 formed simultaneously are individualized, is not represented.

The aforementioned steps a)-f) may be structured by means of known structuring methods, for example electron beam lithography, dry etching methods and the like. Steps d) and e) may furthermore be combined into a single step, by protecting the metal layer 34 with a suitable cover during the structuring.

Production costs of the mask 38 can be reduced by examining the mask 38 after each step, and continuing to carry out the structuring only in the regions where no error has occurred.

1-12. (canceled)

13. A photolithography arrangement, comprising:
an illumination source which emits radiation with a predetermined wavelength directed towards a substrate;
a projection mask for modulating the radiation of the illumination source;
an optical system for imaging the radiation modulated by the projection mask onto the substrate; and
a metal mask comprising a transparent mask carrier and a metal mask arranged thereon, the metal mask being designed to transmit the modulated radiation through the metal mask by means of surface plasmons.

14. The photolithography arrangement as claimed in claim 13, wherein a thickness of the metal mask is a function of the predetermined wavelength, and
wherein the metal mask comprises:
at least one through hole that it is smaller than the predetermined wavelength; and
a grating structure located on a light exit side of the metal mask for converting the surface plasmons into directed light.

15. The photolithography arrangement as claimed in claim 14, wherein the through hole is circular.

16. The photolithography arrangement as claimed in claim 15, wherein the circular through hole is surrounded by annular grating structures.

17. The photolithography arrangement as claimed in claim 14, wherein the through hole has a width which is less than the wavelength.

18. The photolithography arrangement as claimed in claim 17, wherein the metal mask comprises a plurality of grating structures that are arranged perpendicularly to the width of the through hole.

19. The photolithography arrangement as claimed in claim 18, wherein the plurality of grating structures are arranged symmetrically with respect to the through hole.

20. The photolithography arrangement as claimed in claim 18, wherein the grating structures comprise a plurality of elevations and indentations that are arranged non-periodically in the metal mask.

21. The photolithography arrangement as claimed in claim 19, wherein the grating structures comprise a plurality of elevations and indentations, which are arranged non-periodically in the metal mask.

22. The photolithography arrangement as claimed in claim 13, wherein the metal mask is arranged at a distance from the substrate.

23. The photolithography arrangement as claimed in claim 13, wherein the space between the projection mask and the substrate is at least partially filled with an immersion liquid.

24. The photolithography arrangement as claimed in claim 13, wherein the metal mask is made of silver.

25. The photolithography arrangement as claimed in claim 14, wherein the metal mask comprises a second grating structure on the light incidence side, the second grating structure being arranged around the through hole.

26. The photolithography arrangement as claimed in claim 13, wherein the optical system comprises a single lens.

27. The photolithography arrangement as claimed in claim 13, wherein the optical system comprises a plurality of lenses.

28. A photolithography arrangement, comprising:
an illumination source which emits radiation with a predetermined wavelength directed towards a substrate;
a projection mask for modulating the radiation of the illumination source;
an optical system for imaging the radiation modulated by the projection mask onto the substrate; and
a metal mask means, which includes a transparent mask carrier and a metal mask arranged thereon, for transmitting the modulated radiation through the metal mask by means of surface plasmons.

29. A method for producing a metal mask of a photholithography arrangement, the method comprising the steps of:
providing a carrier substrate including an anti-reflection layer one side and a grating structure on the other side;
providing a grated metal layer on a partial region of the grating structure;
forming a through hole in the center of the grating structure; and
applying a thin, non-reflecting layer on regions of the carrier substrate not covered by the grated metal layer and not supporting the through hole.
